(19) United States
(12) Patent Application Publication
(10) Pub. No.: US 2009/0161555 A1
(43) Pub. Date: Jun. 25, 2009

(54) RADIO ACCESS STATION APPARATUS AND METHOD OF CONTROLLING CALL IN PORTABLE INTERNET SYSTEM

(75) Inventor: Jun Ho Chung, Gyeonggi (KR)

Correspondence Address: BLANK ROME LLP, WATERGATE, 600 NEW HAMPSHIRE AVENUE, N.W., WASHINGTON, DC, 20037, US

(73) Assignee: Posdata Co., Ltd.

(21) Appl. No.: 12/159,507

(22) PCT Filed: Dec. 27, 2006
(86) PCT No.: PCT/KR2006/005774

§ 371 Date: Jun. 27, 2008

(30) Foreign Application Priority Data
Dec. 29, 2005 (KR) 10-2005-01335874

(51) Int. Cl. H04W 36/00; H04W 84/02; H04L 12/26; G06F 21/20; H04L 9/06

(52) U.S. Cl. 370/241.1; 370/331; 370/338; 726/4; 713/168

(57) ABSTRACT

Provided are a radio access station (RAS) apparatus and a method of controlling a call in a portable Internet system, that are capable of dispersing traffic concentrated in an access control router (ACR). According to the apparatus and method, an operation, administration and maintenance (OAM) task for operation and management of a RAS, an admission task for call admission processing and service flow control for a portable subscriber station (PSS), a public key manager (PKM) task for authentication and registration of the PSS, a mobility task for handover processing for the PSS, and an account task for accounting are implemented as modules in the RAS. A call control procedure capable of being performed in the RAS is performed in the RAS by the tasks, thereby embodying a RAS-based call control method. Therefore, in comparison with a conventional ACR-based call control method, it is possible to disperse traffic loads concentrated in an ACR and establish an economical network.

### TECHNICAL FIELD

The present invention relates to a radio access station (RAS) apparatus and a method of controlling a call in a portable Internet system, and more particularly, to a RAS apparatus and a call control method that embody several functions associated with call control as tasks in a RAS, enable a RAS-based call control process using the tasks, and thereby can disperse traffic concentrated in an access control router (ACR).

### BACKGROUND ART

In the late 1970's, cellular mobile telecommunication systems were introduced in the United States. This was followed by Korea's advanced mobile phone service (AMPS), an analog mode of a first generation (1G) mobile communication system enabling wireless voice communication. In the mid 1990's, the second generation (2G) mobile communication system was commercialized. This was followed in the late 1990's by commercialization of a part of the International Mobile Telecommunication-2000 (IMT-2000) standard, which has served as a third generation (3G) mobile communication system for providing high-speed wireless multimedia data service.

Nowadays, research is aimed at upgrading the 3G mobile communication system into a fourth generation (4G) mobile communication system. In particular, portable Internet technology is being vigorously researched with the goal of enabling faster data transmission than in a 3G mobile communication system.

The portable Internet satisfies users' demands for high-speed Internet service, anytime, anywhere, via a portable device, and has a ripple effect on the entire information and communication industry in Korea. Therefore, the portable Internet is a new and promising industry, and international standardization of the portable Internet is currently in progress on the basis of Institute of Electrical and Electronics Engineers (IEEE) 802.16e.

When a mobile terminal is connected to a RAS, mobile communication systems including a portable Internet system inform a corresponding ACR, which generally processes call admission, authentication, handover, etc. of the mobile terminal.

Such an ACR-based call control method can easily perform call control because it is possible to recognize a current state of the mobile terminal in real time. However, since the ACR must perform all control functions associated with call management for the mobile terminal, the method is inefficient.

For example, when a mobile terminal provided with a service moves to another sector within the same RAS, handover may be performed by an ACR in the mobile communication systems. Therefore, the mobile communication systems have a problem in that a large amount of traffic is concentrated in the ACR due to unnecessary packet transmission and reception with the mobile terminal.

More specifically, when handover is requested according to movement of a portable subscriber station (PSS), various messages such as a request (REQ) message, a response (RSP) message, an acknowledgement (ACK) message, etc. for RAS switching, user authentication, and service flow control, are sent and received between the PSS and the ACR. When the PSS moves to another sector of the same RAS, handover is performed by exchanging data packets with the ACR, despite the fact that it could be performed by transmitting and receiving messages between channel cards in the RAS. Consequently, a network load is generated at the ACR.

Particularly, in a portable Internet system, handover is frequently needed between RASs according to movement of a PSS due to system characteristics. The ACR-based call control method described above includes the factor of overload to perform handover, and thus is difficult to use in a portable Internet system without modification. Thus, a method of supporting the mobility of a PSS without generating a huge overload is required in portable Internet systems.

Furthermore, a portable Internet system must include high-performance equipment to accommodate a large number of subscribers, but the equipment is costly. Thus, there is need of a way to establish a low-cost network by dispersing traffic to several low-priced RASs instead of high-priced ACR equipment.

### DISCLOSURE OF INVENTION

### Technical Problem

The present invention is directed to performing a call control process that can be performed in a radio access station (RAS) and thereby dispersing traffic loads concentrated in an access control router (ACR).

The present invention is also directed to dispersing traffic loads to several low-priced RASs instead of high-priced ACE equipment and thereby embodying an economical portable Internet system.

### Technical Solution

One aspect of the present invention provides a RAS apparatus in a portable Internet system, the apparatus having a RAS management processor (RMP) module comprising: an operation, administration and maintenance (OAM) unit for performing operation and management of the RAS using an OAM task; an access processor for performing call admission and service flow control for a portable subscriber station (PSS) using an admission task; an authentication processor for performing authentication and registration of the PSS using a public key manager (PKM) task; a handover processor for performing handover of the PSS using a mobility task; and an accounting unit for performing an account process for a service using an account task.

Another aspect of the present invention provides a RAS apparatus in a portable Internet system, the apparatus having an RMP module comprising: an access processor for performing call admission and service flow control for a PSS; an authentication processor for performing authentication and registration of the PSS; and a handover processor for performing handover from the source RAS of the PSS to the target RAS, and when the handover is completed, exchanging a call context between the source RAS and the target RAS.

Still another aspect of the present invention provides an RMP module of a portable Internet system comprising the first RAS, the second RAS, and an ACR controlling the first and second RASs, wherein the first RAS and the second RAS each have an area divided into at least one sector, and the RMP module performs handover of a PSS on the basis of at least one of the first RAS information, the second RAS information, the ACR information, and movement information of the PSS, when the PSS moves to another sector within the first or second RASs, and exchanges a call context between the source RAS and the target RAS when the handover is completed.

Yet another aspect of the present invention provides a method of controlling a call in a portable Internet system, the method comprising the steps of: (a) in the case of a PSS is accessed, performing call admission, authentication and registration for the PSS; (b) in the cased of service addition/change/deletion is requested from the PSS, controlling a service flow; (c) in case of handover is requested from the PSS, performing the handover and transferring a call context of the PSS to a target RAS; and (d) in the case of registration cancellation is requested from the PSS, deleting a database for the PSS to cancel the registration.

### ADVANTAGEOUS EFFECTS

As described above, a variety of functions associated with call control are implemented as modules in task form, and the corresponding task is controlled to be executed according to a signal from a PSS and a RAS, thereby embodying a RAS-based call control method. Consequently, it is possible to prevent an overload from being generated at an ACR and process a large amount of packet data for a service without high-performance ACR equipment, so that an economical network can be constituted.

Meanwhile, the above-described exemplary embodiments of the present invention can be embodied as computer programs stored on computer readable media and capable of being executed by a computer.

As described above, in comparison with a conventional ACR-based call control method, the call control procedure capable of being performed in a RAS according to the present invention is performed by a RAS, and thereby traffic loads concentrated in an ACR can be dispersed.

In addition, according to the present invention, since use of high-priced ACR equipment can be reduced by dispersing traffic loads to several low-priced RASs, it is possible to embody an economical portable Internet system.

In addition, according to the present invention, since a variety of functions associated with call control are implemented by tasks in a RAS, a call control procedure of the RAS can be easily changed by modifying the tasks when necessary.

### BRIEF DESCRIPTION OF THE DRAWINGS

FIG. 1 schematically illustrates a constitution of a portable Internet system employing the present invention;

FIG. 2 is a block diagram of a radio access station (RAS) apparatus of FIG. 1;

FIG. 3 illustrates functions of respective tasks shown in FIG. 2;

FIG. 4 illustrates an example of databases stored in a memory unit shown in FIG. 2;

FIG. 5 is a flowchart illustrating a method of controlling a call in a portable Internet system according to an exemplary embodiment of the present invention;

FIG. 6A illustrates a handover procedure according to a conventional call control method; and

FIGS. 6B and 6C illustrate handover procedures according to a call control method of the present invention.

### MODE FOR THE INVENTION

Hereinafter, exemplary embodiments of the present invention will be described in detail. However, the present invention is not limited to the embodiments disclosed below, but can be implemented in various forms. The following embodiments are described in order for this disclosure to be complete and enabling of practice of the invention by those of ordinary skill in the art.

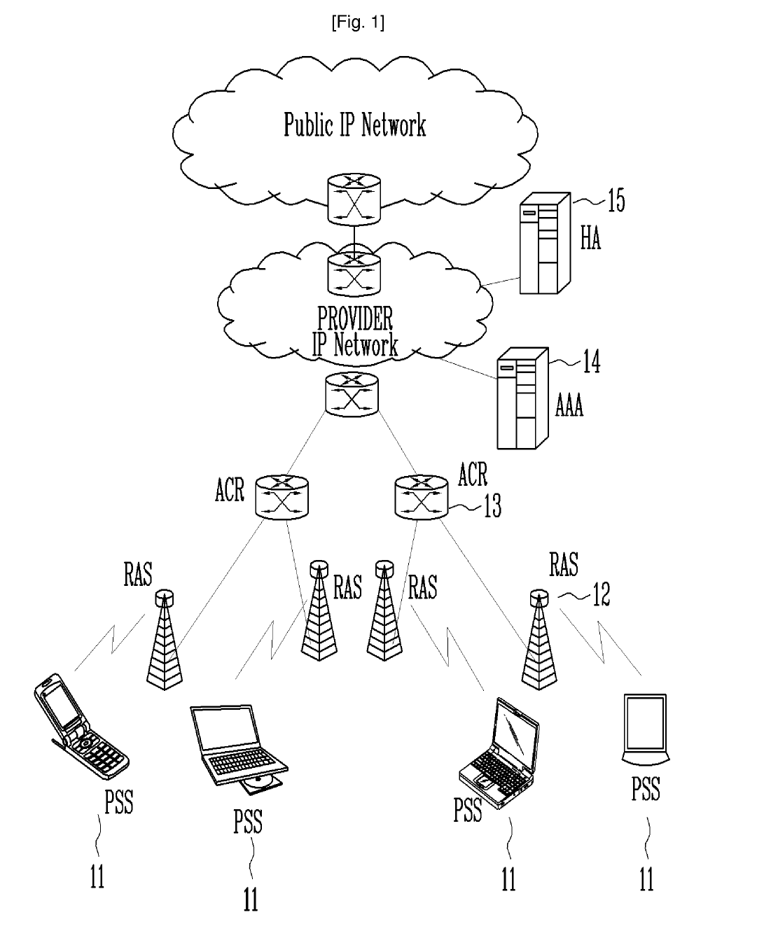

FIG. 1 schematically illustrates a constitution of a portable Internet system employing the present invention.

As illustrated in FIG. 1, the portable Internet system includes portable subscriber stations (PSSs) 11, radio access stations (RASs) 12 performing all control functions associated with connection and servicing of the PSSs 11, access control routers (ACRs) 13 for controlling the RASs 12, an authentication authorization and accounting (AAA) server 14 connected with an Internet protocol (IP) network and performing authentication and account for the PSSs 11, and a home agent (HA) 15 for supporting IP mobility through the IP network. Functions of the PSSs 11, the RASs 12, and the ACRs 13 are briefly described below.

The PSSs 11 have functions of portable Internet wireless access, IP-based service access, IP mobility, terminal/user authentication and security, multicast service reception, and interoperation with another network.

The RASs 12 have functions of portable Internet wireless access, wireless resource management and control, mobility (hand-off) support, authentication and security, quality of service (QoS) provision, downlink multicast, account, and statistical information generation and notification.

The ACRs 13 have functions of IP routing and mobility management, authentication and security, QoS provision, IP multicast, account service, mobility control between RASs within each ACR, and resource management and control.

The PSSs 11 and the RASs 12 perform communication using an Orthogonal Frequency Division Multiple Access (OFDMA) method, which is described below in brief.

The OFDMA method is a multiplexing method combining a frequency division method (FDM), which uses sub carriers of a plurality of orthogonal frequencies as a plurality of sub channels, with a time division method (TDM). Since the OFDMA method is essentially strong at fading generated in a multi-path and has a high data transfer rate, it is possible to obtain optimum transmission rate for high-speed data transfer. Thus, using the OFDMA method, portable Internet systems can provide mobility of PSSs.

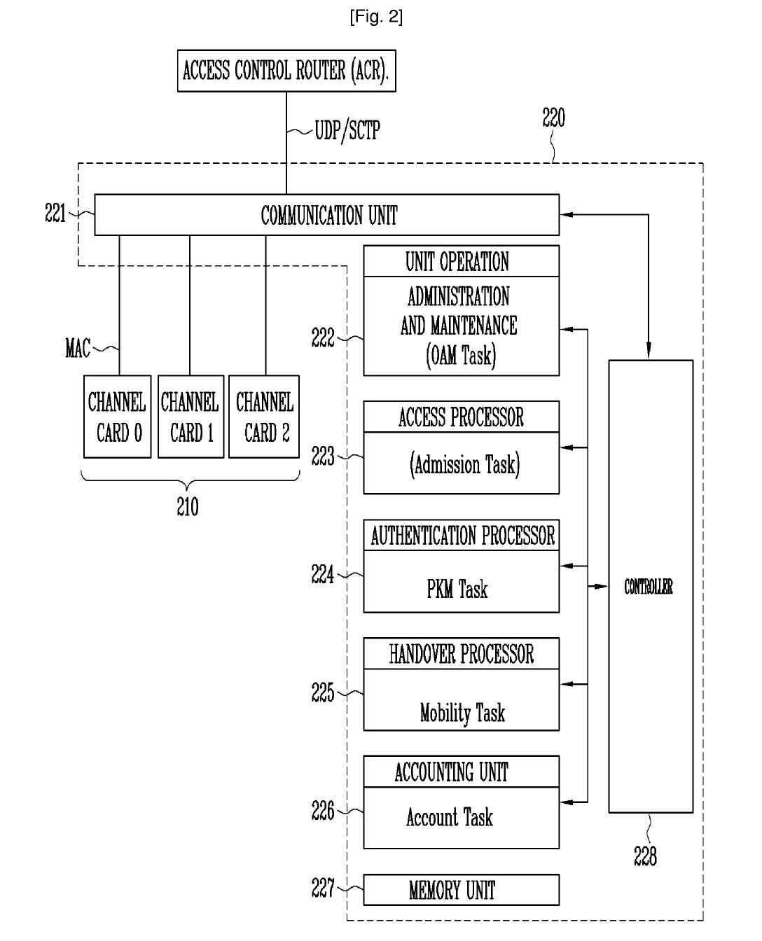

Meanwhile, in the portable Internet system constituted as shown in FIG. 1, the call control function of the ACRs 13 must be dispersed to the RASs 12 so as to minimize traffic concentrated in the ACRs 13. To this end, the present invention embodies a variety of functions associated with call control using respective tasks in the RASs 12 such that a RAS-based call control method can be implemented by the tasks. With reference to FIGS. 2 to 4, the RAS-based call control method will be described in further detail below.

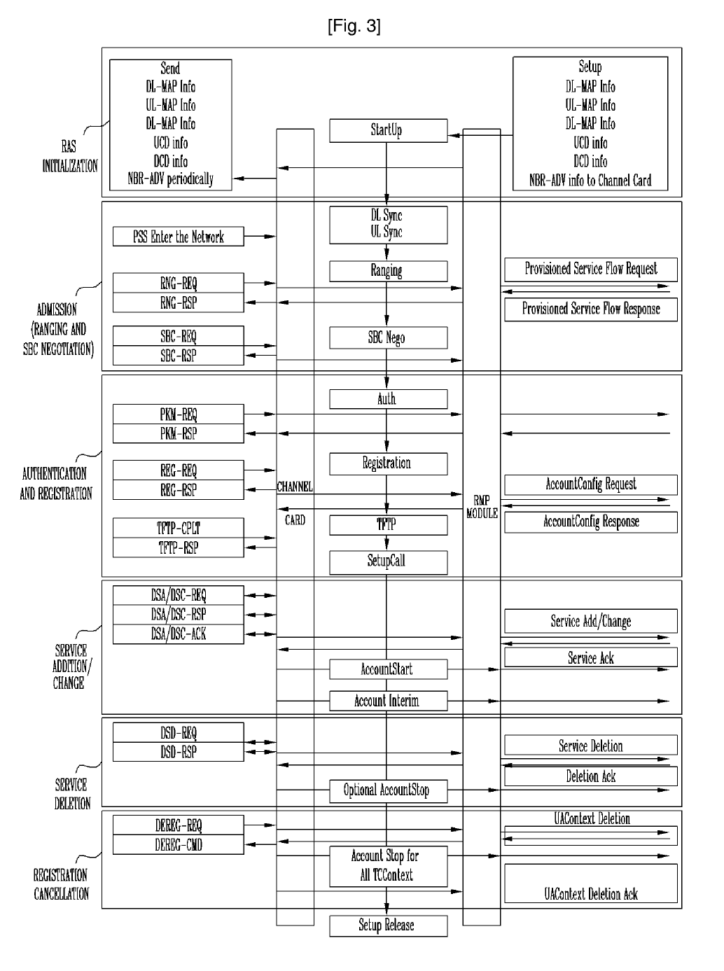

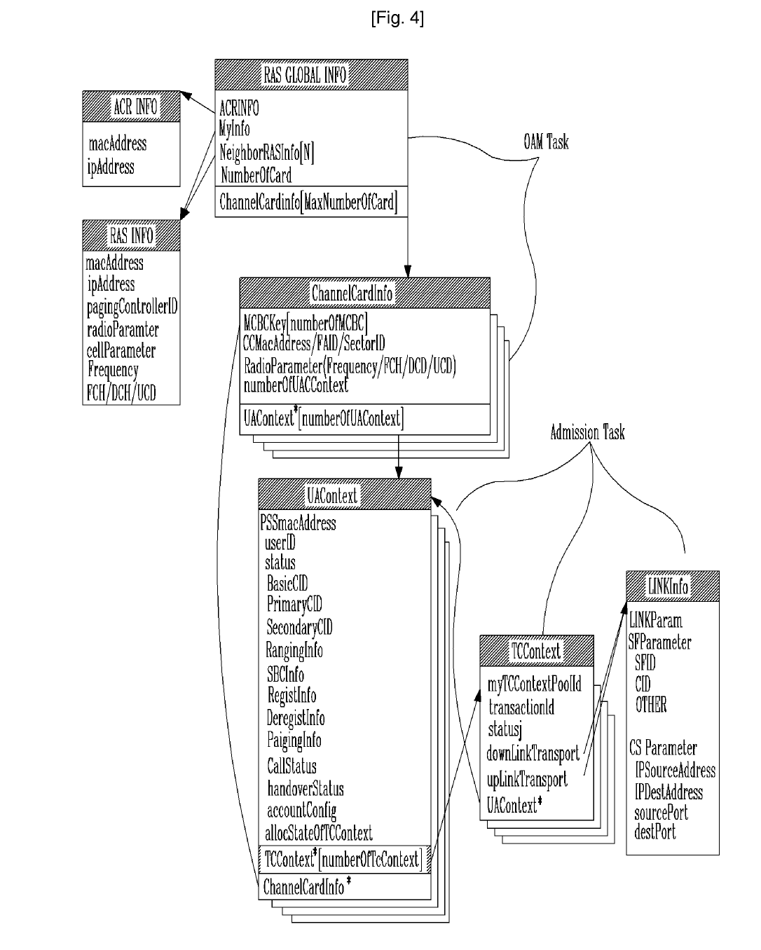

FIG. 2 illustrates a detailed constitution of a RAS apparatus of FIG. 1, FIG. 3 illustrates functions of respective tasks shown in FIG. 2, and FIG. 4 illustrates an example of databases stored in a memory unit shown in FIG. 2.

As illustrated in FIG. 2, the RAS apparatus according to an exemplary embodiment of the present invention includes a plurality of channel cards 210 exchanging wireless signals with a PSS 11 and a RAS management processor (RMP) module 220 for RAS management. The RMP module 220 includes: a communication unit 221 for communication with the channel cards 210 and an ACR 13; an operation, administration and maintenance (OAM) unit 222 for RAS status management; an access processor 223 for call admission processing; an authentication processor 224 for user authentication; a handover processor 225 for performing handover of a PSS; an accounting unit 226 for service accounting; a memory unit 227 for storing information required for call control; and a controller 228 for controlling operation of each unit according to a signal input through the communication unit 221.

The communication unit 221 transmits and receives data to and from the ACR 13 and an element management system (EMS, not shown in the drawings), which is a network management system, using a user datagram protocol (UDP)/stream control transmission protocol (SCTP), and to and from the channel chards 210 using a media access control (MAC) protocol.

The OAM unit 222 sets up all databases to be managed by the unit itself on the basis of information on channel cards, a RAS thereof (first RAS), a neighbor RAS (second RAS), an ACR controlling the first RAS or the second RAS, etc., and performs functions associated with operation and management of the RAS on the basis of the databases. Such a RAS management function is performed by an OAM task described below.

The controller 228 controls the below-described respective tasks according to a signal input through the communication unit 221. If the OAM unit 222 includes the task control function, the controller 228 can be omitted to simplify the constitution.

The access processor 223 performs an admission process for the PSS 11 and establishes a database containing network access information, service flow information, service link information, etc., and controls a call state of the PSS 11 on the basis of the database. Such a call state of the PSS 11 is controlled by an admission task described below.

The authentication processor 224 performs authentication of the PSS 11 and a user by a public key manager (PKM) task. The handover processor 225 performs a handover process of the PSS 11 using a mobility task. The accounting unit 226 performs service accounting functions using an account task. The OAM task, the admission task, the PKM task, the mobility task, and the account task will be described in detail below.

To aid in understanding the present invention, it is assumed that the above-mentioned tasks have been implemented in advance and thus, when the apparatus for managing a RAS operates, the tasks are loaded into a memory and can be controlled by each unit.

(1) OAM task

When a RAS 12 is initialized, the OAM task configures all the channel cards 210 belonging to the RAS 12, receives information on wireless parameters from the network management system (EMS), sets wireless parameters of a channel card 210 to be managed by the task on the basis of the information, and establishes a channel card information database.

More specifically, as illustrated in FIG. 3, the OAM task receives downlink-mobile application protocol (DL-MAP) information for resource allocation, uplink channel descriptor (UCD) information for cell synchronization, neighbor-advertisement (NBR-ADV) information for handover, etc. from the ACR management system (EMS), establishes the channel card information database on the basis of the information, and stores the database in the memory unit 227. FIG. 4 illustrates an example of the channel card information database established in this way.

As illustrated in FIG. 4, the channel card information database (ChannelCardInfo) stores various information, e.g., a MAC address (CCMacAddress), a frequency area identification (frequency area ID (FAID)), and a sector ID (SectorID), of the channel cards 210 included in the RAS 12.

In addition, the OAM task establishes a RAS global information database on the basis of information on the first RAS, the second RAS, the ACR controlling the first RAS or the second RAS, etc., stores the database in the memory unit 227, and then performs RAS fault management, performance management and statistical processing on the basis of the database. As illustrated in FIG. 4, the RAS global information database (RAS GLOBAL INFO) stores ACR information (ACRinfo), first RAS information (Myinfo), second RAS information (NeighborRASInfo), and so on.

Furthermore, the OAM task performs a database management function for a simple network management protocol (SNMP) relating to network monitoring.

In brief, the OAM task sets up all databases to be managed by the task itself on the basis of information on the channel cards, the first RAS, the second RAS, and the ACR controlling the first RAS or the second RAS, and performs an OAM function for the RAS on the basis of the database.

(2) Admission task

The admission task controls a connection process and service flow for the PSS 11. Admission task functions will be described in detail below.

First, as illustrated in FIG. 3, the PSS 11 performs downlink synchronization (DL Sync) and uplink synchronization (UP Sync), thereby attempting network access.

Subsequently, the admission task receives an access request message (RNG-REQ) from the PSS 11 and finds out the MAC address of the PSS 11. When the ranging request is successful, the admission task transmits a ranging response message (RNG-RSP) to the PSS 11 and then stores the MAC address in an authentication information space.

When the ranging process is finished, the admission task performs a subscriber basic capability (SBC) negotiation procedure for the PSS 11. In the SBC negotiation procedure, the PSS 11 first transmits an SBC negotiation request message (SBC-REQ) to the RAS 12, and the admission task receives the message and transmits a response message (SBC-RSP) in response to the received message to the PSS 11. By the SBC negotiation, a network entry procedure of the PSS 11 is completed.

Meanwhile, the admission task generates a user agent context database on the basis of network entry procedure content. As illustrated in FIG. 4, the user agent context database (UAContext) stores network access information for the PSS 11 such as a MAC address (PSSMacAddress) allocated to the PSS 11, a user ID (userID), a call connection status (status), a connection ID (BasicCID) for delay-sensitive message transfer, a connection ID (PrimaryCID) for less-delay-sensitive message transfer, ranging information (RandingInfo), SBC negotiation information (SBCInfo), registration information (Registinfo), handover status information (handoverStatus), and so on.

Here, the user agent context database stores the network access information for the PSS 11 and thus can be considered the same as a network access information database in this exemplary embodiment.

Referring back to FIG. 3, when a service addition/change message (DSA/DSC-REQ) is received from the PSS 11, the admission task informs the ACR 13, transmits a response message (DSA/DSC-RSP) in response to the received message to the PSS 11, and generates a transmission convergence context database for a service flow and a service link information database for a service link, thereby providing the corresponding service to the PSS 11 on the basis of the databases.

As illustrated in FIG. 4, the transmission convergence context database (TCContext) stores information such as transmission convergence (myTCContextPoolID), a transaction ID (transactionID), a service status (statusj), downlink transport (downLinkTransport), uplink transport (upLinkTransport), etc. The service link information database (Linkinfo) stores information such as a service flow connection ID (service flow CID (SFID)), a CID, an IP source address (IPSourceAddress), an IP destination address (IPDestAddress), a source port (SourcePort), a destination port (destPort), etc.

Here, the transmission convergence context database stores information relating to a service flow and thus may be considered the same as a service flow information database in this exemplary embodiment.

Meanwhile, when a service deletion request message (DSD-REQ) is received from the PSS 11, the RAS 12 informs the ACR 13 of the service deletion and the admission task deletes the transmission convergence context database and the service link information database for the corresponding service and then terminates the service.

In brief, the admission task generates/changes/deletes the transmission convergence context database (TCContext) and the service link information database (LinkInfo) according to service flow generation/change/deletion, thereby functioning to control a service flow for the PSS 11.

Meanwhile, when handover is completed, the admission task of the source RAS 12 deletes the user agent context database (UAContext), the transmission convergence context database (TCContext) and the service link information database (Linkinfo), and an admission task performed in a target RAS 12 generates a new user agent context database (UAContext), transmission convergence context database (TCContext) and service link information database (Linkinfo).

In addition, as illustrated in FIG. 3, when a registration-cancellation request message (DEREG-REQ) is received from the PSS 11 due to handover or power down, the admission task deletes the user agent context database (UAContext), the transmission convergence context database (TCContext) and the service link information database (Linkinfo) and transmits the registration-cancellation result to the PSS 11 and the ACR 13, thereby completing a registration-cancellation procedure.

(3) PKM Task

The PKM task is for authentication of the PSS 11 and a user and controls authentication policy and key exchange between the PSS 11 and the ACR 13.

As illustrated in FIG. 3, first, the PSS 11 transmits a subscriber-authentication request message (PKM-REQ) to the RAS 12. The PKM task receives the message, performs authentication using the AAA server 14, and then transmits a subscriber-authentication response message (PKM-REQ) to the PSS 11.

Subsequently, when the PSS 11 transmits a registration request message (REG-REQ) to the RAS 12, the PKM task receives the message, registers the PSS 11 in the network, and then transmits a registration response message (REG-RSP) to the PSS 11.

When it is checked that the registration of the PSS 11 is successful, the PSS 11 transmits a trivial file transfer protocol (TFTP) complete message (TFTP-CPLT) for a file download path, and the RAS 12 sends a response message (TFTP-RSP) in response to the TFTP-CPLT message to the PSS 11, thereby completing call setup for the PSS 11.

(4) Account Task

The account task performs an account process. As illustrated in FIG. 3, when the PSS 11 requests a new service, the account task transmits an account start message (AccountStart) informing of the start of account to the ACR 13 or an account server (not shown in the drawings), and transmits an account information message for each service flow to the ACR 13 or the account server according to an interim accounting report.

In addition, when a service-stop request message is received from the PSS 11, the account task transmits an account stop message (Account Stop) informing of the stop of account and an account information message for data packets that are provided so far to the ACR 13 or the account server.

(5) Mobility Task

The mobility task performs handover of the PSS 11 and, when handover is requested from the PSS 11, performs handover in consideration of a current environment and conditions.

More specifically, when the PSS 11 moves out of a current cell area to another cell area, the mobility task performs handover appropriate for a current environment and conditions according to the first RAS information, the second RAS information, the ACR information including the first RAS information or the second RAS information, and movement information. When the handover is completed, the mobility task exchanges a call context between a source RAS and a target RAS and then transmits a handover completion message to the PSS 11, thereby enabling a current service to be continuously provided regardless of movement of the PSS 11.

Call context exchange between the source RAS and the target RAS is a process in which the mobility task of the source RAS 12 transfers a user agent context database (UAContext), a transmission convergence context database (TCContext) and a service link information database (Linkinfo) to the mobility task of the target RAS 12 so as to enable a service to be directly provided without the above-described network entry procedure and authentication procedure.

The above-described call context exchange between the source RAS and the target RAS is applied in the same way to a case in which the PSS 11 moves to another RAS 12 registered in the same ACR 13.

Meanwhile, when the PSS 11 moves to another sector within the same RAS or moves from a sector within the first RAS to a sector within the second RAS, handover is simply enabled by changing channel card information among the network access information of the PSS 11 without performing call context exchange as described above. This is because each RAS stores all information on the PSS 11.

In brief, when the PSS 11 moves to another sector within the same RAS or from a sector within the first RAS to a sector within the second RAS, the mobility task changes information on a channel card (ChannelCardInfo) to which the PSS 11 belongs in the user agent context database (UAContext) of the RAS, thereby allowing handover to be performed by data processing in the RAS.

As described above, several functions associated with call control are respectively implemented by tasks in the RASs 12, and operations that can be processed in the RASs 12, e.g., OAM of the RASs 12, access of the PSS 11, user authentication, service account, a handover procedure, etc., are processed by the respective tasks. Consequently, traffic concentrated in the ACR 13 can be dispersed to the RASs 12.

A method of managing a RAS in a portable Internet system according to an exemplary embodiment of the present invention will be described in detail below with reference to the appended drawings.

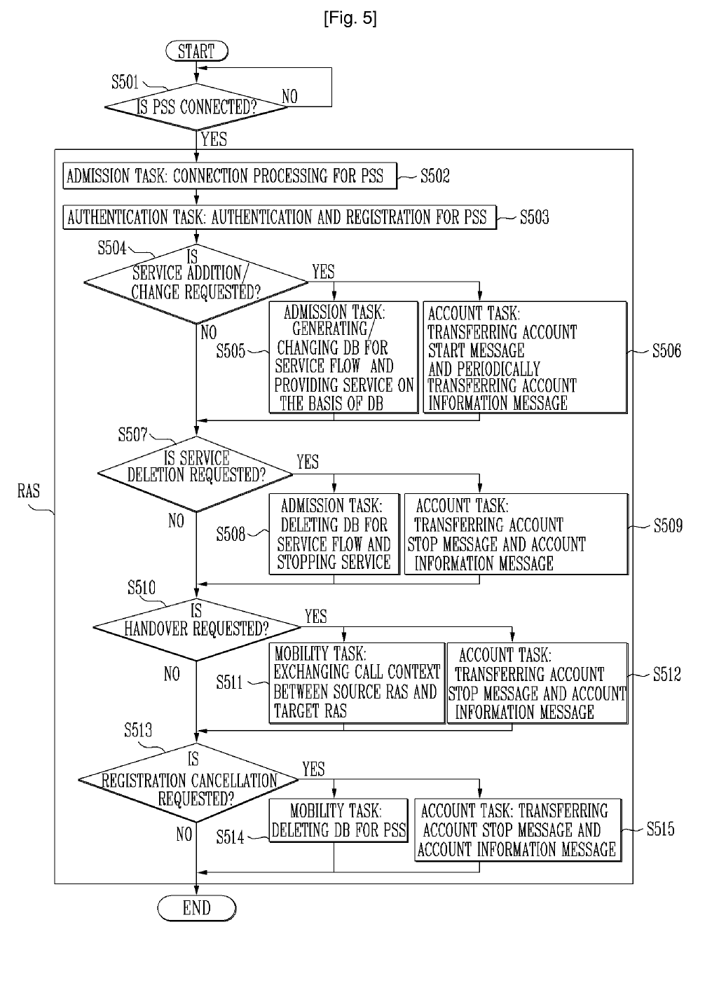

FIG. 5 is a flowchart illustrating a method of controlling a call in a portable Internet system according to an exemplary embodiment of the present invention. For convenience, it is assumed that all databases and tasks required for call control are prepared in advance.

First, when a PSS 11 is accessed to a network in step 501, a RAS 12 performs ranging and SBC negotiation using an admission task to process access of the PSS 11 in step 502.

Subsequently, the RAS 12 performs authentication and registration of the PSS 11 in step 503, thereby completing call setup between the PSS 11 and the RAS 12.

When call setup between the PSS 11 and the RAS 12 is completed through the above-described process, the RAS 12 generates a user agent context database (UAContext) using the admission task on the basis of a network entry procedure.

Subsequently, when service addition/change is requested from the PSS 11 in step 504, the RAS 12 generates a transmission convergence context database (TCContext) for a service flow and service link information database (Linkinfo) for a service link using the admission task, thereby allowing the corresponding service to be provided to the PSS 11 on the basis of the databases in step 505.

Here, in step 506, the RAS 12 transmits a message (AccountStart) informing of the start of account to an ACR 13 or an account server (not shown in the drawings) using the account task, transmits an account information message for each service flow to the ACR 13 or the account server according to an interim accounting report.

Meanwhile, when a service deletion request is received from the PSS 11 in step 507, the RAS 12 deletes the transmission convergence context database and the service link information database for the corresponding service flow to stop service provision in step 508, and then transmits an account stop message (Account Stop) for the corresponding service and an account information message for data packets that are provided so far to the ACR 13 or the account server using the account task in step 509.

Subsequently, when the PSS 11 moves out of the source cell area to another cell area, i.e., handover is requested from the PSS 11, in step 510, the RAS 12 performs handover appropriate for a current environment and conditions using the mobility task, and when the handover is completed, exchanges a call context between the source RAS and the target RAS, thereby enabling a current service to be continuously provided in step 511.

Here, when the PSS 11 moves to another sector within the same RAS 12, the RAS 12 changes information (ChannelCardInfo) on a channel card to which the PSS 11 belongs in the user agent context database (UAContext), thereby allowing handover to be performed by data processing in the RAS 12. When the PSS 11 moves to a sector within another RAS 12 registered within the same ACR 13, the RASs perform handover by call context exchange between the source RAS and the target RAS.

In addition, when the handover is completed, the RAS 12 transmits an account stop message (Account Stop) for the corresponding service and an account information message for data packets that are provided so far to the ACR 13 or the account server using the account task in step 512.

Subsequently, when a registration cancellation request is received from the PSS 11 in step 513, the RAS 12 deletes databases for the PSS 11, e.g., the user agent context database (UAContext), the transmission convergence context database and the service link information database, using the admission task to perform registration cancellation of the PSS 11 in step 514. In step 515, the RAS 12 transmits an account stop message (Account Stop) for the corresponding service and an account information message for data packets that are provided so far to the ACR 13 or the account server using the account task.

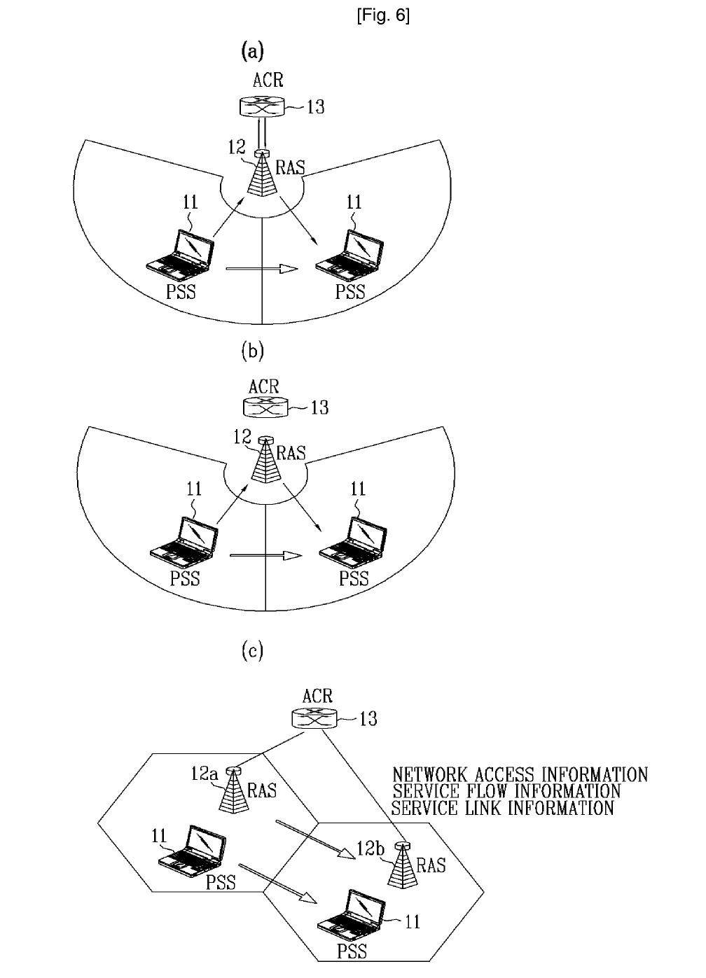

FIG. 6A illustrates a handover procedure according to a conventional call control method, and FIGS. 6B and 6C illustrate handover procedures according to a call control method of the present invention.

According to a conventional call control method, as illustrated in FIG. 6A, when a terminal moves to another sector within the same RAS 12, handover is performed by an ACR 13 despite the fact that it can be performed by data processing in the corresponding RAS 12. Thus, all traffic loads are concentrated in the ACR 13. On the other hand, according to the call control method of the present invention, as illustrated in FIG. 6B, handover is performed by data processing in the RAS 12. Consequently, the handover procedure is simplified in comparison with the conventional method.

In addition, as illustrated in FIG. 6C, when a PSS 11 moves from a sector within the first RAS 12a to a sector of within the second RAS 12b, the first RAS (source RAS) 12a performs handover and transfers only network access information, service flow information and service link information of the PSS 11 to the second RAS (target RAS) 12b according to the call control method of the present invention. In brief, the handover is accomplished not by the ACR 13 but by call context exchange between the source RAS 12a and the target RAS 12b. Thus, it can be seen that the handover procedure is simplified in comparison with the conventional method.

As described above, a variety of functions associated with call control are implemented as modules in task form, and the corresponding task is controlled to be executed according to a signal from a PSS and a RAS, thereby embodying a RAS-based call control method. Consequently, it is possible to prevent an overload from being generated at an ACR and process a large amount of packet data for a service without high-performance ACR equipment, so that an economical network can be constituted.

Meanwhile, the above-described exemplary embodiments of the present invention can be embodied as computer programs stored on computer readable media and capable of being executed by a computer.

As described above, in comparison with a conventional ACR-based call control method, the call control procedure capable of being performed in a RAS according to the present invention is performed by a RAS, and thereby traffic concentrated in an ACR can be dispersed.

In addition, according to the present invention, since use of high-priced ACR equipment can be reduced by dispersing traffic loads to several low-priced RASs, it is possible to embody an economical portable Internet system.

In addition, according to the present invention, since a variety of functions associated with call control are implemented by tasks in a RAS, a call control procedure of the RAS can be easily changed by modifying the tasks when necessary.

While the invention has been shown and described with reference to certain exemplary embodiments thereof, it will be understood by those skilled in the art that various changes in form and details may be made therein without departing from the spirit and scope of the invention as defined by the appended claims.

1. A radio access station (RAS) apparatus in a portable Internet system having a RAS management processor (RMP) module, comprising:
an operation, administration and maintenance (OAM) unit for performing operation and management of the RAS using an OAM task;
an access processor for performing call admission and service flow control for a portable subscriber station (PSS) using an admission task;
an authentication processor for performing authentication and registration of the PSS using a public key manager (PKM) task;
a handover processor for performing handover of the PSS using a mobility task; and
an accounting unit for performing an account process for a service using an account task.

2. The RAS apparatus of claim 1, further comprising:
a channel card for transmitting and receiving data to or from the PSS through a wireless channel.

3. The RAS apparatus of claim 1, wherein the RMP module further comprises:
a communication unit for communication with the channel card and an access control router (ACR); and
a memory unit for storing information required for call control.

4. The RAS apparatus of claim 1, wherein the OAM task performs operation and management of the RAS on the basis of at least one of channel card information, a source RAS information, a target RAS information, and ACR information including the source RAS information and the target RAS information.

5. The RAS apparatus of claim 1, wherein the admission task performs ranging procedures and subscriber basic capability (SBC) negotiation procedures, and obtains network access information of the PSS.

6. The RAS apparatus of claim 1, wherein the admission task generates or changes service flow information and service link information to allow the PSS to be provided with a corresponding service when a service addition or change message is received from the PSS, and deletes service flow information and service link information to stop the service provided to the PSS when a service deletion message is received from the PSS.

7. The RAS apparatus of claim 1, wherein the admission task deletes information data of the PSS when a registration cancellation message is received from the PSS.

8. The RAS apparatus of claim 1, wherein the mobility task performs handover on the basis of at least one of first RAS information, second RAS information, an ACR information including the first RAS information and the second RAS information and movement information, and when the handover is completed, transmits at least one of network access information, service flow information, and service link information of the PSS to a target RAS.

9. A RAS apparatus in a portable Internet system having an RMP module comprising:
an access processor for performing call admission and service flow control for a PSS;
an authentication processor for performing authentication and registration of the PSS; and
a handover processor for performing handover from a source RAS of the PSS to a target RAS, and when the handover is completed, exchanging a call context between the source RAS and the target RAS.

10. The RAS apparatus of claim 9, wherein the call context comprises network access information, service flow information, and service link information of the PSS.

11. The RAS apparatus of claim 9, wherein the RMP module changes channel card information of network access information of the PSS when the PSS moves to another sector within the source or the target RAS.

12. The RAS apparatus of claim 9, wherein the RMP module performs operation and management of the RAS on the basis of at least one of channel card information, the source RAS information, the target RAS information, and ACR information including the source RAS information and the target RAS information.

13. The RAS apparatus of claim 9, wherein the RMP module performs call admission and service flow control for the PSS.

14. The RAS apparatus of claim 9, wherein the RMP module further comprises a network access information database of the PSS, and the network access information database of the PSS includes at least one of a media access control (MAC) address, a user identification (ID), a call connection status, connection ID (CID) information, ranging information, SBC negotiation information, registration information, and handover status information.

15. The RAS apparatus of claim 9, wherein the RMP module further comprises a service flow information database, and the service flow information database includes at least one of transmission convergence information, a transaction ID, a service status, downlink transport information, and uplink transport information.

16. The RAS apparatus of claim 9, wherein the RMP module further comprises a service link information database, and the service link information database includes at least one of a service flow connection ID, an Internet protocol (IP) source address, an IP destination address, source port information, and destination port information.

17. The RAS apparatus of claim 9, further comprising:
a channel card for transmitting and receiving data to or from the PSS through a wireless channel.

18. The RAS apparatus of claim 9, further comprising:
a communication unit for communication with the channel card and an ACR; and
a memory unit for storing information required for call control.

19. A method of controlling a call in a portable Internet system, comprising the steps of:
(a) when a PSS is accessed, performing call admission, authentication and registration for the PSS;
(b) when a service addition/change/deletion is requested from the PSS, controlling a service flow;
(c) when a handover is requested from the PSS, performing the handover and transferring a call context of the PSS to a target RAS; and
(d) when a registration cancellation is requested from the PSS, deleting a database for the PSS to cancel the registration.

20. The method of claim 19, after step (d), further comprising the step of:
(e) performing operation and management of the RAS on the basis of at least one of channel card information, first RAS information, second RAS information, and an ACR information including the first RAS information and the second RAS information.

21. The method of claim 19, wherein step (a) comprises the step of:
performing a ranging procedure and a subscriber basic capability (SBC) negotiation procedure for the PSS and obtaining network access information of the PSS.

22. The method of claim 19, wherein step (b) comprises the steps of:
when a service of addition/change message is received from the PSS, generating/changing service flow information and service link information to provide the PSS with a corresponding service; and
when a service of deletion message is received from the PSS, deleting service flow information and service link information to stop the service provided to the PSS.

23. The method of claim 19, wherein step (c) comprises the steps of:
performing handover of the PSS on the basis of at least one of the first RAS information, second RAS information, information on an ACR controlling the first RAS and the second RAS and movement information; and
transferring network access information, service flow information, and service link information of the PSS to the target RAS.

24. The method of claim 19, wherein step (c) comprises the step of:
when the PSS moves to another sector within the first RAS and the second RAS, changing channel card information of network access information of the PSS.

25. An RMP module in a portable Internet system comprising a first RAS, a second RAS, and an ACR controlling the first and second RASs, wherein the first RAS and the second RAS each have an area divided into at least two sectors, and
the RMP module performs handover of a PSS on the basis of at least one of the first RAS information, the second RAS information, the ACR information, and movement information of the PSS, when the PSS moves to another sector within the first or second RASs, and exchanges a call context between a source RAS and a target RAS when the handover is completed.
